(19) United States
(12) Patent Application Publication
(10) Pub. No.: US 2012/0206651 A1
(43) Pub. Date: Aug. 16, 2012

(54) SPEAKER SYSTEM, VIDEO DISPLAY DEVICE, AND TELEVISION RECEIVER

(76) Inventor: Hidenori Minoda, Osaka-shi (JP)

(21) Appl. No.: 13/503,679

(22) PCT Filed: Oct. 25, 2010
(86) PCT No.: PCT/JP2010/068866

§ 371 Date: Apr. 24, 2012

(30) Foreign Application Priority Data
Oct. 26, 2009 (JP) 2009-245696

(51) Int. Cl. H04R 1/02; H04N 7/00

(52) U.S. Cl. 348/552; 381/388; 348/E07.001

(57) ABSTRACT

A speaker system of a television receiver (1) includes a plurality of speakers each consisting of at least two speaker units of the same kind positioned in such a manner that acoustic-wave-radiating surfaces thereof face each other, and the distance between said at least two speaker units is larger than the diameter of each of said at least two speaker units.

### TECHNICAL FIELD

The present invention relates to a speaker system including speakers for outputting sounds, a video display device, and a television receiver.

### BACKGROUND ART

Recently, video display devices having a speaker system are getting larger. An example of such large video display devices is a television receiver (which may be hereinafter referred to as TV). In such a large TV, speakers are positioned at the lower side or outside the right and left sides of a TV screen or positioned both at the lower side and outside the right and left sides of the TV screen. Speakers are positioned in such a manner that their vibration surfaces are parallel to the screen and face in the same direction as the screen, i.e. a front direction. Furthermore, for individual channels of the TV, there are provided at least one L (left) channel speaker and at least one R (right) channel speaker, respectively.

Such a large TV employs a virtual sound using crosstalk cancellation etc. The crosstalk cancellation is designed such that in order to cancel a sound which is not desired to be heard by a right ear, a control signal with an opposite phase is outputted from Lch, thereby yielding a three-dimensional acoustic effect. Furthermore, there is a TV equipped with an enhancer for mixing harmonic sounds with actual sounds to enhance the sounds.

However, in such a large TV, the distance between an Lch speaker and an Rch speaker is large. Furthermore, since the TV itself serves as a baffle board, distribution of a wave surface is disturbed more greatly as the distance from the front of the speaker is larger. Consequently, such a large TV suffers a problem that the change in acoustic characteristics differs greatly depending on where a viewer views the TV.

Furthermore, thinness of a TV is likely to cause an unnecessary sound derived from propagation of speakers' vibration to a cabinet. Such an unnecessary sound must be prevented.

Patent Literature 1 discloses a high-quality sound speaker designed such that a pair of speaker units are positioned on the same line to face each other, allowing a user to hear a more there-dimensional sound image.

Furthermore, Patent Literature 2 discloses an omnidirectional acoustic converter designed such that vibration plates of two acoustic conversion units are positioned to be as close as possible so that acoustic waves are radiated efficiently in a horizontal direction or a vertical direction to be omnidirectional.

Furthermore, Patent Literature 3 discloses a television receiver designed such that a speaker for high notes is provided inside a sound conduit to control sound image localization, allowing a user to enjoy surround-sound with exactly localized sound images.

Furthermore, there prevails a TV, such as a one disclosed in Non-patent Literature 1, which is designed such that speakers are provided at the lower side and outside the right and left sides of a TV screen to surround the TV screen so as to yield a virtual sound effect using crosstalk cancellation etc.

### CITATION LIST

### Patent Literatures

### [Patent Literature 1]

Japanese patent Application Publication, Tokukai, No. 2005-318484 (published on Nov. 10, 2005)

### [Patent Literature 2]

Japanese patent Application Publication, Tokukaihei, No. 2-260899 (published on Oct. 23, 1990)

### [Patent Literature 3]

Japanese patent Application Publication, Tokukai, No. 2001-359199 (published on Dec. 26, 2001)

### Non-Patent Literatures

### [Non-Patent Literature 1]

Sharp Corporation, “AQUOS”, [online], [retrieved on Sep. 9, 2009], Internet <URL:http://www.sharp.co.jp/aquos/lineup/gx5_{—}65/feature04.html>

### SUMMARY OF INVENTION

### Technical Problem

However, the above conventional techniques have problems below.

The technique described in Patent Literature 1 is excellent in terms of omnidirectionality in a horizontal direction. However, since a pair of speaker units are positioned to be close to each other, omnidirectionality in a vertical direction is low. Furthermore, in order to secure omnidirectionality in a vertical direction, it is necessary to form a front horn from curves of baffle surfaces.

Furthermore, since the technique described in Patent Literature 2 is designed such that two acoustic conversion units are positioned to be close to each other like Patent Literature 1, the technique has low omnidirectionality in a vertical direction.

Furthermore, since the technique described in Patent Literature 3 is designed to include a sound conduit, the technique has sharp directionality of a sound pressure. Consequently, when a user is not in front of opening of the sound conduit, the user experiences extreme change in acoustic characteristics. That is, the technique does not provide omnidirectionality.

Furthermore, in the case of a TV such as a one described in Non-patent Literature 1 which yields a virtual sound effect using crosstalk cancellation etc., as the TV gets larger, the change in acoustic characteristics greatly differs depending on where a user views the TV.

The present invention was made in view of the foregoing problems. An object of the present invention is to provide a speaker system which outputs, in a wide range, sounds with a little change in frequency characteristics of sound pressure, i.e. sounds with excellent omnidirectionality.

### Solution to Problem

In order to solve the foregoing problems, a speaker system of the present invention is a speaker system including a plurality of speakers respectively positioned outside both ends of a display screen of a display, each of the plurality of speakers consisting of at least two speaker units of the same kind positioned in such a manner that acoustic-wave-radiating surfaces thereof face each other, a distance between said at least two speaker units being larger than a diameter of each of said at least two speaker units.

With the arrangement, in the speaker system of the present invention, each of the plurality of speakers respectively positioned outside both ends of the display screen consists of at least two speaker units of the same kind positioned in such a manner that the acoustic-wave-radiating surfaces thereof face each other, and the distance between said at least two speaker units is larger than the diameter of each of said at least two speaker units.

Since said at least two speaker units are positioned in such a manner that the acoustic-wave-radiating surfaces thereof face each other, said at least two speaker units can obtain omnidirectionality. Furthermore, the distance between the speaker units is larger than the diameter of each speaker unit. That is, since the speaker units are not positioned too closely, the speaker units can obtain excellent omnidirectionality also in a vertical direction which is a longitudinal direction of the display. Thus, it is possible to yield a wide-ranged virtual sound effect using crosstalk cancellation etc. Accordingly, a user can hear sounds with excellent omnidirectionality even if the user is not positioned in front of the speaker system.

Furthermore, since the two speaker units are positioned in such a manner that the acoustic-wave-radiating surfaces thereof face each other, it is possible to cancel vibrations. Thus, it is possible to prevent unnecessary vibration sounds coming from a cabinet etc. other than the speaker. Consequently, it is possible to prevent chattering noises coming from housing due to large sounds. Furthermore, by cancelling vibrations, it is possible to prevent the Doppler effect resulting from vibration of a video display device etc. itself including the speaker system.

Consequently, the speaker system of the present invention can output, in a wide range, sounds with a little change in frequency characteristics of sound pressure, i.e. sounds with excellent omnidirectionality.

The scope of the present invention also encompasses a video display device including the speaker system and a television receiver including the video display device.

For a fuller understanding of another object, characteristics, and advantages of the invention, reference should be made to the ensuing detailed description. Furthermore, advantages of the invention will be clearly understood in the ensuing explanation taken in conjunction with the accompanying drawings.

### Advantageous Effects of Invention

The speaker system of the present invention is a speaker system including a plurality of speakers respectively positioned outside both ends of a display screen of a display, each of the plurality of speakers consisting of at least two speaker units of the same kind positioned in such a manner that acoustic-wave-radiating surfaces thereof face each other, a distance between said at least two speaker units being larger than a diameter of each of said at least two speaker units. Therefore, the speaker system of the present invention can output, in a wide range, sounds with a little change in frequency characteristics of sound pressure, i.e. sounds with excellent omnidirectionality.

### BRIEF DESCRIPTION OF DRAWINGS

FIG. 1

FIG. 1 is a view of a configuration of a television receiver in accordance with an embodiment of the present invention.

FIG. 2

FIG. 2 is an enlarged view of an Lch speaker in accordance with an embodiment of the present invention.

FIG. 3

FIG. 3 is a graph showing a relation between frequency and sound pressure in accordance with an embodiment of the present invention.

FIG. 4

FIG. 4 is an enlarged view of a center ch speaker in accordance with an embodiment of the present invention.

FIG. 5

(a) of FIG. 5 is a bottom view of a woofer, and (b) of FIG. 5 is a cross sectional view of the woofer, each in accordance with an embodiment of the present invention.

FIG. 6

(a) of FIG. 6 is a top view of a television receiver, and (b) of FIG. 6 is a cross sectional view of the television receiver, each in accordance with an embodiment of the present invention.

FIG. 7

FIG. 7 is a view of another configuration of a television receiver in accordance an embodiment of the present invention.

FIG. 8

FIG. 8 is a view of another configuration of a television receiver in accordance an embodiment of the present invention.

### DESCRIPTION OF EMBODIMENTS

The following explains one embodiment of the present invention with reference to FIGS. 1 to 8.

In the present embodiment, an explanation is made as to a television receiver 1 including a speaker system. However, the present invention is not limited to this. That is, the present invention also encompasses video display devices in general which include a speaker system and which are designed such that speakers are mounted on a monitor (display) without a tuner and an image or a video image for presentation is displayed.

### (Configuration of Television Receiver 1)

Initially, with reference to FIG. 1, an explanation is made as to a configuration of the television receiver 1 including a speaker system in accordance with the present embodiment. FIG. 1 is an elevation view of the television receiver 1. As shown in FIG. 1, the television receiver 1 includes an L (left) ch speaker 2, an R (right) ch speaker 4, a center ch speaker 6 (third speaker), a woofer 8, a tone setting section 10, a sensor 11, a display 12, a speaker cabinet 13 for the woofer 8, and speaker fixing columns 14 and 14′.

The Lch speaker 2 is positioned outside the left side of the display 12 seen from the front. The Rch speaker 4 is positioned outside of the right side of the display 12 seen from the front. The Lch speaker 2 and the Rch speaker 4 are fixed to the speaker fixing columns 14 and 14′, respectively. The speakers of the television receiver 1 are 3.1 speakers.

### (Omnidirectionality of Lch Speaker 2 and Rch Speaker 4)

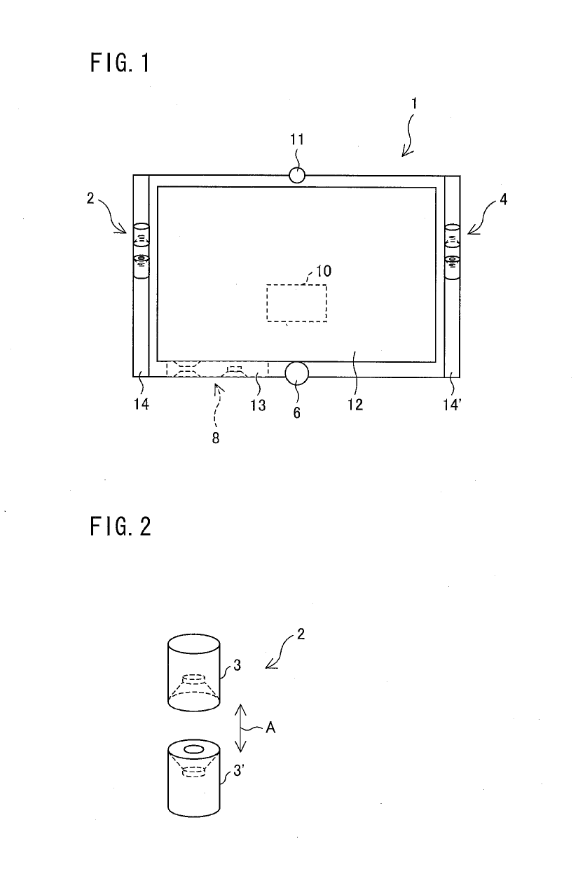

Next, with reference to FIG. 2, an explanation is made as to the Lch speaker 2 and the Rch speaker 4. FIG. 2 is an enlarged view of the Lch speaker 2. It should be noted that the Rch speaker 4 is configured similarly with the Lch speaker 2 and yields a similar effect. As shown in FIG. 2, the Lch speaker 2 includes two speaker units which have the same round shape of 1 inch in diameter and which are positioned in such a manner that acoustic-wave-radiating surfaces thereof face each other. The two speaker units are enclosed in separate enclosures 3 and 3′, respectively.

With the configuration, the Lch speaker 2 can obtain omnidirectionality. Furthermore, the distance between the speaker units is larger than the diameter of each speaker unit. That is, since the two same speaker units are not positioned too closely, the Lch speaker 2 can obtain excellent omnidirectionality also in a vertical direction which is a longitudinal direction of the display 12. Thus, it is possible to yield a wide-ranged virtual sound effect using crosstalk cancellation etc. Accordingly, a user can hear sounds with excellent omnidirectionality even if the user is not positioned in front of the TV receiver but positioned closer to the right side or left side of the TV receiver. Therefore, even if a large number of users view the TV receiver, each user can hear sounds with excellent omnidirectionality.

Furthermore, since the two speakers are positioned to face each other, it is possible to cancel vibrations in directions indicated by an arrow A. Thus, it is possible to prevent unnecessary vibration sounds coming from a cabinet etc. other than the speaker. Consequently, it is possible to prevent chattering noises coming from housing due to large sounds. Furthermore, it is possible to prevent the Doppler effect resulting from vibration of the television receiver 1 itself.

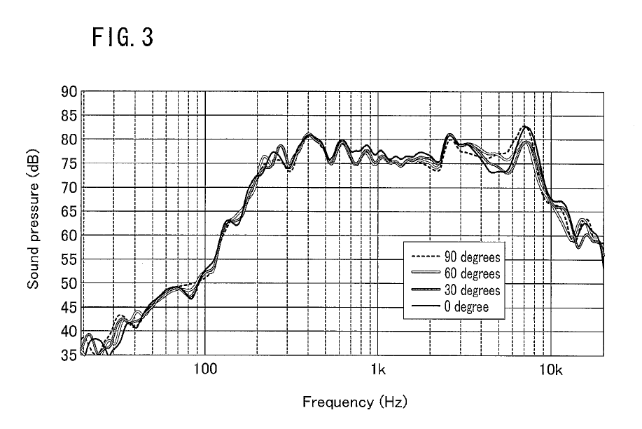

Next, with reference to FIG. 3, an explanation is made as to an omnidirectional effect yielded by the Lch speaker 2 and the Rch speaker 4. FIG. 3 is a graph showing a relation between frequency and sound pressure at individual relative positions to the television receiver 1. “0 degree” indicates a position in front of the television receiver 1, and “90 degrees” indicate a position just beside the television receiver 1.

As is seen from the graph, in the television receiver 1, even in a case of high frequency close to 10 kHz (kilohertz), sound pressure characteristics do not vary greatly depending on the relative position to the television receiver 1. In other words, there is only a little change in frequency characteristics of sound pressure in a wide range. Accordingly, a user can hear sounds with excellent omnidirectionality at any position. Although not shown in the drawing, in the case of high frequency close to 10 KHz, a speaker which cannot obtain omnidirectionality suffers a great change in sound pressure characteristics depending on the relative position to the television receiver 1.

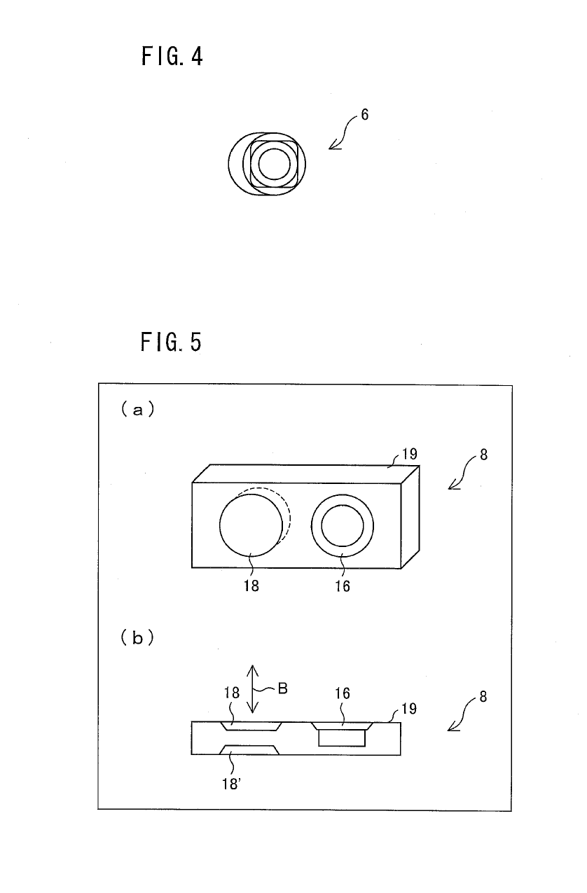

Next, with reference to FIG. 4, an explanation is made as to the center ch speaker 6. FIG. 4 is an enlarged view of the center ch speaker 6. The center ch speaker 6 shown in the drawing has a round shape with a diameter of approximately 50 mm and is fixed at substantially the central lower side of the television receiver 1 in such a manner that an extremely small box containing the center ch speaker 6 is attached or the center ch speaker 6 is directly attached to the main body of the television receiver 1. The center ch speaker 6 mainly outputs human voices. Since a monophonic component is outputted from the center ch speaker 6, speeches of a person can be outputted from the center of the display 12 while right and left sound images spread. Therefore, particularly in a case where the television receiver 1 is large, it is possible to prevent a user from experiencing uncomfortable feelings.

Furthermore, in the television receiver 1, the Lch speaker 2, the Rch speaker 4, and the center ch speaker 6 are positioned in such a manner that the centroid of a triangle with the three speakers at its corners is positioned inside the display screen of the display 12. This positioning allows a user to feel as if sounds came from inside of the display screen of the display 12. In a case where there are a plurality of Lch speakers 2 or a plurality of Rch speakers 4, the speakers are positioned in such a manner that the centroid of a polygon with all the speakers at its corners is positioned inside the display screen of the display 12.

Next, with reference to FIG. 5, an explanation is made as to the woofer 8. (a) of FIG. 5 is a view of the woofer 8 that mainly outputs low sounds seen from the bottom of the television receiver 1. (b) of FIG. 5 is a view of the woofer 8 seen from the front of the television receiver 1. As shown in (b) of FIG. 5, the woofer 8 includes a speaker 16 which is a round unit with a diameter of approximately 60 mm, two passive radiators 18 and 18′ which have a round shape with a diameter of approximately 60 mm and which are positioned in such a manner that acoustic-wave-radiating surfaces thereof face each other, and an enclosure 19. In actual use, the woofer 8 is fixed inside the television receiver 1 in consideration of design and is not seen from the outside.

Since the two passive radiators 18 and 18′ are positioned to face each other as above, it is possible to cancel vibrations in directions indicated by an arrow B. In the television receiver 1, the woofer 8 is positioned to be closer to the left side of the television receiver 1 when seen from the front. Alternatively, the woofer 8 may be positioned to be closer to the r ight side of the television receiver 1. Alternatively, separate woofers 8 may be positioned to be closer to the right side and the left side, respectively, of the television receiver 1. Furthermore, as shown in (b) of FIG. 5, positioning the woofer 8 to face downward allows the frame of the television receiver 1 to be seem thin. Furthermore, the two passive radiators 18 and 18′ may be enclosed in the enclosure 19 for the woofer 8. Furthermore, the enclosure 19 may be included and fixed in the speaker cabinet 13 shown in FIG. 1.

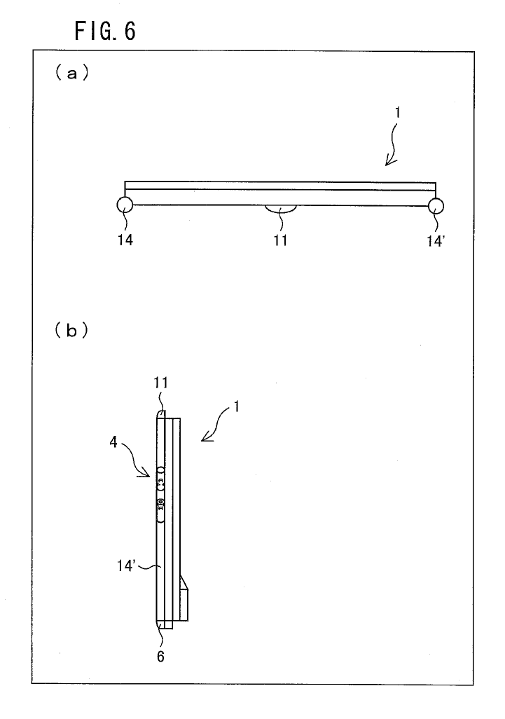

Next, with reference to FIG. 6, an explanation is made as to positioning of the Lch speaker 2 and the Rch speaker 4. (a) of FIG. 6 is a top view of the television receiver 1. (b) of FIG. 6 is a cross sectional view of the television receiver 1 seen from the left. As shown in (a) of FIG. 6, the speaker fixing column 14′ is designed such that one-fourth thereof is fixed to the television receiver 1 and three-fourth thereof is exposed, i.e. exposed to air.

Consequently, one-fourth of sounds output from the Rch speaker 4 is reflected at the one-fourth (portion corresponding to 90 degrees) of the speaker fixing column 14′ by the television receiver 1 serving as a baffle board, but three-fourth of the sounds is exposed at the three-fourth (portion corresponding to 270 degrees) of the speaker fixing column 14′, i.e. exposed to air. Consequently, it is possible to obtain sufficient omnidirectionality. Furthermore, since the portion corresponding to 90 degrees is fixed to the television receiver 1, the speaker fixing column 14′ does not get off the television receiver 1 itself. That is, by fixing the speaker fixing column 14′ in this manner, it is possible to secure both omnidirectionality of sounds and robustness of the television receiver 1. Since the speaker fixing column 14 is fixed to the television receiver 1 at a portion corresponding to 90 degrees in the same manner as the speaker fixing column 14′, the same effect is yielded. In the above example, the portion corresponding to 270 degrees is exposed to air. Alternatively, a portion corresponding to 180 degrees may be exposed to air and a portion corresponding to remaining 180 degrees may be fixed to the television receiver 1.

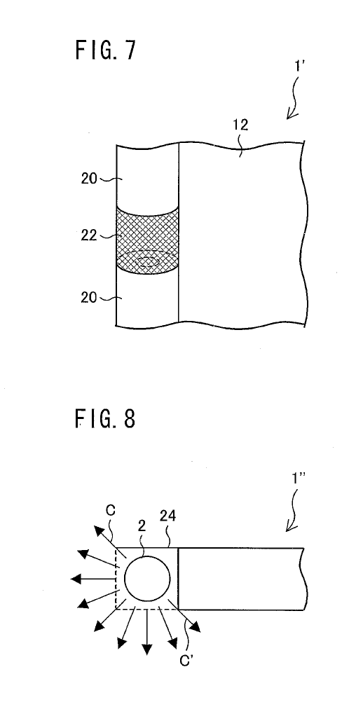

Alternatively, the Lch speaker 2 and the Rch speaker 4 may be fixed to the television receiver 1 without using the speaker fixing column 14 or 14′. This is explained below with reference to FIGS. 7 and 8.

FIG. 7 is an elevation view of a television receiver 1′. The Lch speaker 2 is included in a speaker cabinet 20, and acoustic waves from the Lch speaker 2 are radiated via a speaker net 22. As above, the Lch speaker 2 and the Rch speaker 4 may be fixed to the speaker cabinet 20 mounted on the television receiver 1′.

Furthermore, FIG. 8 is a top view of a television receiver 1″. As shown in FIG. 8, the Lch speaker 2 may be fixed to a plate-shaped cabinet 24 mounted on the television receiver 1″ by screws. By fixing the Lch speaker 2 to the television receiver 1″ in this manner, it is possible to radiate acoustic waves in a range of 180 degrees counterclockwise from an arrow C to an arrow C′. As described above, there are many possible ways to fix the Lch speaker 2 and the Rch speaker 4.

Next, an explanation is made as to the note setting section 10. As shown in FIG. 1, the note setting section is built as a circuit substrate in the television receiver 1, and is integrated with an LSI (Large-Scale Integrated Circuit) which is a main chip for video images or serves as an LSI for audios.

The note setting section 10 controls sounds output from the Lch speaker 2, the Rch speaker 4, and the center ch speaker 6 in accordance with information on a content to be reproduced, thereby setting a note most suitable for a user. For example, in a case where a content to be reproduced is a news program, the note setting section 10 enhances sounds from the center ch speaker 6 which mainly outputs voices, allowing a user to more easily hear the voice of an announcer who reads news. In this case, sound image localization of sounds output from the center ch speaker 6 is arranged to be virtually on the same height as sound image localization of sounds output from the Lch speaker 2 and the Rch speaker 4.

In a case where a volume control is “low”, the note setting section 10 enhances sounds from the center ch speaker 6, or in a case where sounds from the center ch speaker 6 are monophonic, the note setting section 10 puts amplifiers of the Lch speaker 2 and the Rch speaker 4 in off-states, thereby reducing power consumption. Furthermore, in a case where a remote controller is not directed in a front direction of the display 12, the note setting section 10 emphasizes sounds from the center ch speaker 6.

Furthermore, in a case where a content to be reproduced is a 2 channel music, the note setting section 10 may put an amplifier of the center ch speaker 6 in an off-state, thereby reducing power consumption. Furthermore, the note setting section 10 may control the Lch speaker 2 and the Rch speaker 4 to set a note suitable for a user to hear music comfortably. Similarly, in a case where a content to be reproduced is a movie or a drama, the note setting section 10 may set a note suitable for the movie or the drama, so that the user can hear a note most suitable for the content to be reproduced.

Judgment of content information may be made, for example, based on genre information included in program information included in a digital broadcasting, or may be made in such a manner that actual audio signals are analyzed in terms of spectrum distribution or formant components to classify the audio signals into music and conversations and the result of the classification is used.

Furthermore, the note setting section 10 may set a note in accordance with information sensed by the sensor 11. For example, in a case where the sensor 11 is a sensor with a camera for sensing a person, the note setting section 10 may set a note depending on who is the person sensed by the sensor 11. More specifically, the sensor 11 analyzes an image of the person captured by the camera, and judges that the person in the image is a father among preregistered persons. In this case, the note setting section 10 may set a note registered in advance as the note for the father.

### (Additional Note)

The present invention is not limited to the description of the embodiments above, but may be altered by a skilled person within the scope of the claims. An embodiment based on a proper combination of technical means disclosed in different embodiments is encompassed in the technical scope of the present invention.

### SUMMARY OF EMBODIMENTS

As described above, it is preferable to arrange the speaker system of the present invention such that from a space between the two speaker units, acoustic waves are radiated in a range of at least 180 degrees from a direction parallel to the acoustic-wave-radiating surfaces of the two speaker units.

With the arrangement, from the space between the two speaker units, acoustic waves are radiated in the range of at least 180 degrees from a direction parallel to the acoustic-wave-radiating surfaces of the two speaker units. Radiation of acoustic waves in the range of at least 180 degrees yields a further effect of obtaining sufficient omnidirectionality.

It is preferable to arrange the speaker system of the present invention so as to further include a plurality of speaker fixing columns for supporting the plurality of speakers, respectively, each of the plurality of speaker fixing columns being fixed to the speaker system in such a manner that a portion corresponding to 180 degrees or less of a circumference of said each of the plurality of speaker fixing columns is fixed to the speaker system.

With the arrangement, each of the plurality of speaker fixing columns is fixed to the speaker system in such a manner that the portion corresponding to 180 degrees or less of the circumference of said each of the plurality of speaker fixing columns is fixed to the speaker system. In other words, a portion corresponding to 180 degrees or more of the circumference of said each of the plurality of speaker fixing columns is exposed, i.e. exposed to air. Consequently, a portion corresponding to 180 degrees or more of each of the plurality of speakers fixed to the plurality of speaker fixing columns is exposed, i.e. exposed to air. This enables each speaker to obtain sufficient omnidirectionality.

Furthermore, since the portion corresponding to 180 degrees or less, i.e. 90 degrees, is fixed to the speaker system, each of the plurality of speaker fixing columns does not get off the speaker system. This yields a further effect of securing both omnidirectionality of sounds and robustness of the speaker system.

It is preferable to arrange the speaker system of the present invention so as to further include a speaker for outputting a voice, the speaker being positioned outside an end of the display screen of the display, a polygon with the plurality of speakers and the speaker for outputting a voice at its corners has a centroid inside the display screen of the display.

With the arrangement, the speaker system includes the speaker for outputting a voice. Since a monophonic component such as a voice is outputted from the third speaker, speeches etc. of a person can be outputted from the center of the screen while right and left sound images spread. Therefore, particularly in a case of a large video display device etc. including the speaker system etc., it is possible to prevent a user from experiencing uncomfortable feelings.

Furthermore, the polygon with the plurality of speakers and the speaker for outputting a voice at its corners has a centroid inside the display screen of the display. This positioning allows a user to feel as if sounds came from inside of the display screen of the display. This yields a further effect that the user can hear sounds comfortably.

It is preferable to arrange the speaker system of the present invention so as to further include a woofer including two passive radiators, the woofer being positioned outside an end of the display screen of the display, the two passive radiators being positioned in such a manner that acoustic-wave-radiating surfaces thereof face each other.

With the arrangement, the speaker system includes the woofer for mainly outputting low sounds. Since the two passive radiators are positioned in such a manner that acoustic-wave-radiating surfaces thereof face each other, there is yielded a further effect that vibrations can be cancelled.

It is preferable to arrange the speaker system of the present invention such that the two passive radiators are enclosed in an enclosure for the woofer.

With the arrangement, the two passive radiators are enclosed in an enclosure for the woofer. Accordingly, the passive radiators are not seen from the outside of the speaker system. Consequently, there is yielded a further effect that the outlook of the speaker system is improved.

It is preferable to arrange the speaker system of the present invention such that the enclosure for the woofer is fixed by being included in a speaker cabinet positioned outside an end of the display screen of the display.

With the arrangement, the enclosure for the woofer is fixed by being included in the speaker cabinet. Accordingly, the enclosure is not seen from the outside of the speaker system. Consequently, there is yielded a further effect that the outlook of the speaker system is improved.

It is preferable to arrange the speaker system of the present invention such that said at least two speaker units are enclosed respectively in separate enclosures positioned closely to each other.

With the arrangement, the two speaker units are enclosed respectively in separate enclosures. Accordingly, there is yielded a further effect that the two speaker units can be enclosed respectively in separate enclosures.

It is preferable to arrange the speaker system of the present invention so as to further include a note setting section for reading information on a content to be reproduced, and controlling, in accordance with the read information, sounds output from the plurality of speakers and the speaker for outputting a voice.

With the arrangement, the note setting section controls, in accordance with information on a content to be reproduced, sounds output from the plurality of speakers and the speaker for outputting a voice. Consequently, the note content setting section can set a note suitable for the content. For example, in a case where the content is a news program, the note setting section enhances sounds from the third speaker which mainly outputs voices. That is, a user can hear sounds suitable for individual contents. Furthermore, there is yielded a further effect that an amplifier of an unused speaker is put in an off-state in accordance with the content to be reproduced, thereby reducing power consumption.

It is preferable to arrange the speaker system of the present invention so as to further include a sensor for identifying a person, the note setting section controlling a sound depending on the person identified by the sensor.

With the arrangement, the sensor identifies a person, and the note setting section controls a sound depending on the person identified by the sensor. Accordingly, there is yielded a further effect that notes can be set individually for preferences of a plurality of persons.

The concrete embodiments or examples of implementation discussed in the foregoing detailed explanation serve solely to illustrate the technical details of the present invention, which should not be narrowly interpreted within the limits of such concrete embodiments or examples, but rather may be applied in many variations within the spirit of the present invention, provided such variations do not exceed the scope of the patent claims set forth below.

### INDUSTRIAL APPLICABILITY

The speaker system of the present invention is preferably applicable to large video display devices etc. in general including a speaker system.

### REFERENCE SIGNS LIST

1, 1′, 1″. Television receiver
2. Lch speaker (a plurality of speakers)
3, 3′. Enclosure for speaker unit
4. Rch speaker (a plurality of speakers)
6. Center ch speaker (speaker for outputting a voice)
8. Woofer
10. Note setting section
11. Sensor
12. Display
13. Speaker cabinet for woofer
14, 14′. Speaker fixing column
16. Speaker
18, 18′. Passive radiator
19. Enclosure for woofer
20. Speaker cabinet for Lch speaker
22. Speaker net
24. Plate-shaped cabinet

1. A speaker system, comprising a plurality of speakers respectively positioned outside both ends of a display screen of a display,
each of the plurality of speakers consisting of at least two speaker units of a same kind positioned in such a manner that acoustic-wave-radiating surfaces thereof face each other, a distance between said at least two speaker units being larger than a diameter of each of said at least two speaker units.

2. The speaker system as set forth in claim 1, wherein from a space between said two speaker units, acoustic waves are radiated in a range of at least 180 degrees from a direction parallel to the acoustic-wave-radiating surfaces of said two speaker units.

3. The speaker system as set forth in claim 2, further comprising a plurality of speaker fixing columns for supporting the plurality of speakers, respectively,
each of the plurality of speaker fixing columns being fixed to the speaker system in such a manner that a portion corresponding to 180 degrees or less of a circumference of said each of the plurality of speaker fixing columns is fixed to the speaker system.

4. The speaker system as set forth in claim 1, further comprising a speaker for outputting a voice, the speaker being positioned outside an end of the display screen of the display,
a polygon with the plurality of speakers and the speaker for outputting a voice at its corners has a centroid inside the display screen of the display.

5. The speaker system as set forth in claim 1, further comprising a woofer including two passive radiators, the woofer being positioned outside an end of the display screen of the display,
the two passive radiators being positioned in such a manner that acoustic-wave-radiating surfaces thereof face each other.

6. The speaker system as set forth in claim 5, wherein the two passive radiators are enclosed in an enclosure for the woofer.

7. The speaker system as set forth in claim 6, wherein the enclosure for the woofer is fixed by being included in a speaker cabinet positioned outside an end of the display screen of the display.

8. The speaker system as set forth in claim 1, wherein said at least two speaker units are enclosed respectively in separate enclosures positioned closely to each other.

9. The speaker system as set forth in claim 4, further comprising a note setting section for reading information on a content to be reproduced, and controlling, in accordance with the read information, sounds output from the plurality of speakers and the speaker for outputting a voice.

10. The speaker system as set forth in claim 9, further comprising a sensor for identifying a person,
the note setting section controlling a sound depending on the person identified by the sensor.

11. A video display device, comprising a speaker system as set forth in claim 1.

12. A television receiver, comprising a video display device as set forth in claim 11.
